(19) United States
(12) Patent Application Publication
(10) Pub. No.: US 2011/0027653 A1
(43) Pub. Date: Feb. 3, 2011

(54) NEGATIVE PLATE FOR LEAD ACID BATTERY

(76) Inventors: Marvin C. Ho, Yorba Linda, CA (US); Gordon C. Beckley, Grayson, GA (US); Colin Smith, Grayson, GA (US); Charles E. Snyder, Placentia, CA (US)

Correspondence Address: CHRISTIE, PARKER & HALE, LLP, PO BOX 7068, PASADENA, CA, 91109-7068, US

(21) Appl. No.: 12/534,719

(22) Filed: Aug. 3, 2009

(51) Int. Cl. H01M 4/56

(52) U.S. Cl. 429/225

(57) ABSTRACT

Capacitor pastes for flooded deep discharge lead-acid batteries include lead oxide, a carbon additive, and an aqueous acid. The capacitor paste contains lead and carbon in a lead to carbon mass ratio of about 5:1 to 82:1. Hybrid negative plates for flooded deep discharge lead-acid batteries can be made using such pastes in combination with traditional pastes. The hybrid negative plates include a capacitor paste on a bottom portion of the plate, and a traditional paste on the remainder of the plate. Batteries using the capacitor paste and hybrid plates exhibit improved performance over batteries with conventional plates and pastes and require less overcharge to prevent electrolyte stratification.

### FIELD OF THE INVENTION

The present invention relates to flooded or wet cell lead-acid electrochemical batteries, and more particularly to negative hybrid electrodes for use in such batteries and to methods of making and using the same.

### BACKGROUND OF THE INVENTION

A typical flooded lead-acid battery includes positive and negative plates and an electrolyte. Positive and negative active materials are manufactured as pastes that are coated on the positive and negative electrode grids, respectively, forming positive and negative plates. The positive and negative active material pastes generally comprise lead oxide (PbO or lead (II) oxide). The electrolyte typically includes an aqueous acid solution, most commonly sulfuric acid (H₂SO₄). Once the battery is assembled, the battery undergoes a formation step in which a charge is applied to the battery in order to convert the lead oxide of the positive plates to lead dioxide (PbO₂ or lead (IV) oxide) and the lead oxide of the negative plates to lead.

After the formation step, a battery may be repeatedly discharged and charged in operation. During battery discharge, the positive and negative active materials react with the sulfuric acid of the electrolyte to form lead (II) sulfate (PbSO₄). By the reaction of the sulfuric acid with the positive and negative active materials, a portion of the sulfuric acid of the electrolyte is consumed. However, under normal conditions, sulfuric acid returns to the electrolyte upon battery charging. The reaction of the positive and negative active materials with the sulfuric acid of the electrolyte during discharge may be represented by the following formulae.

Reaction at the negative electrode:

Pb(s)+SO₄²⁻(aq) [symbol] PbSO₄(s)+2e⁻

Reaction at the positive electrode:

PbO₂(s)+SO₄²(aq)+4H⁺+2e⁻ [symbol] PbSO₄(s)+2(H₂O)(l)

As shown by these formulae, during discharge, electrical energy is generated, making the flooded lead-acid battery a suitable power source for many applications. For example, flooded lead-acid batteries may be used as power sources for electric vehicles such as forklifts, golf cars, electric cars, and hybrid cars. Flooded lead-acid batteries are also used for emergency or standby power supplies, or to store power generated by photovoltaic systems.

To charge a flooded lead-acid battery, the discharge reaction is reversed by applying a voltage from a charging source. During charging, the lead sulfate reacts with oxygen molecules from ionized water to produce lead and lead dioxide. The lead dioxide is deposited on the positive electrode and the lead is deposited on the negative electrode.

During the normal cycling application, the batteries need to receive enough charge in order to convert lead sulfate back to active materials (lead dioxide for the positive electrode and lead for the negative electrode). Insufficient charge will cause the accumulation of lead sulfate at both the positive and negative plates, and thus reduce the performance and life of a lead-acid battery.

Additionally, over time, the electrolyte may stratify such that the acid electrolyte concentration is higher at the bottom of the battery compared to the top of the battery. Such an increase in the concentration causes increased accumulation of lead sulfate at the bottom of the negative electrode, shortening the life of a lead-acid battery. The traditional method to remedy stratification is to overcharge a battery, causing gas generation by consuming a portion of the electrolyte. The resulting gas bubbles cause the electrolyte to mix. However, a high amount of overcharging causes excessive water loss, positive grid alloy corrosion, and shorted battery life.

### SUMMARY OF THE INVENTION

An embodiment of the present invention is directed to a hybrid negative plate for a flooded deep discharge lead-acid battery. Such a hybrid negative plate contains both a capacitor region and a traditional region. The capacitor region could be made of a capacitor paste. The capacitor paste could be a carbon paste. The traditional region could be made of lead oxide paste. In some embodiments, the capacitor region is oriented at the bottom of the negative plate and the traditional region is the remainder of the negative plate.

Another embodiment of the invention is directed to a method for preparing a hybrid negative plate for a flooded deep discharge lead-acid battery. Such a method includes adding a capacitor paste to a portion of an electrode grid and then applying a lead oxide paste to the remainder of the electrode grid. In some embodiments, the capacitor paste is applied to a bottom portion of the electrode grid, and the lead oxide paste is applied to the remainder of the electrode grid.

In another embodiment of the present invention, a flooded deep cycling lead-acid battery includes a hybrid negative plate.

Another embodiment of the present invention is directed to a capacitor paste for a flooded deep discharge lead-acid battery. Such a capacitor paste includes lead oxide, a capacitor additive, and sulfuric acid. The capacitor paste may optionally include a binder such as carboxymethyl cellulose, neoprene, polyvinylidene fluoride (PVDF) or polytetrafluoroethylene (PTFE). According to one embodiment the capacitor additive is a combination of one or more of carbon black, graphite, and activated carbon. For such an embodiment, the carbon additive may be present in the paste in an amount of about 1% to 20% of the mass of the lead oxide on a dry basis. This generally corresponds to a lead to carbon mass ratio for the capacitor paste of from about 5:1 to 82:1.

Another embodiment of the invention is directed to a method for preparing a capacitor paste for a flooded deep discharge lead-acid battery. Such a method includes mixing lead oxide, carbon, and an expander to form a dry mixture, adding water to the dry mixture and wet-mixing the resulting mixture. Acid is then added to form the capacitor paste.

In another embodiment of the present invention, a flooded deep discharge lead-acid battery includes the capacitor paste. The capacitor paste is applied to the negative electrode grid.

When compared to a conventional flooded deep discharge lead-acid battery of similar size and weight that does not include a capacitor paste, a flooded deep discharge lead-acid battery that includes a carbon additive at the bottom portion of the negative plate tends to increase the amount of gas bubbles that are produced at the bottom of the battery, thus reducing stratification and reducing the amount of overcharge needed when charging a battery. Therefore, a battery of the present invention can provide reduced maintenance and a longer cycle life compared to a conventional battery.

### BRIEF DESCRIPTION OF THE DRAWINGS

The accompanying drawings, together with the specification, illustrate various aspects and embodiments of the invention.

FIG. 1 is a schematic sectional view of a flooded deep discharge lead-acid battery according to one embodiment of the present invention;

FIG. 2 is a view of a hybrid negative plate according to one embodiment of the present invention; and

FIGS. 3 through 15 are graphs showing the results of testing comparing hybrid negative plates according to embodiments of the present invention with both traditional negative plates and capacitor negative plates.

### DETAILED DESCRIPTION OF THE INVENTION

According to one embodiment of the invention, a hybrid negative plate for a flooded deep discharge lead-acid battery is a negative electrode with a capacitor region and a traditional region, where the capacitor region is oriented at the bottom of the plate. The capacitor region could be made of a capacitor paste. The traditional region could be made of lead oxide paste and may include other additives.

The term capacitor is used to describe the characteristic of the capacitor material of storing charge on its surface. Traditional lead-acid battery electrodes, unlike capacitors, store charge by causing an electrochemical reaction. Capacitor regions are generally comprised of a high surface area substance, as the high surface area allows for a high rate of charge and discharge, and thus high current. High current capability is useful in gas-electric hybrid vehicle applications or similar applications during discharge where high power is needed for acceleration and during charge where high current is applied from regenerative braking.

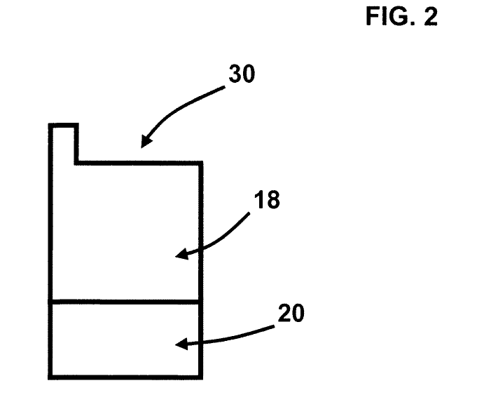

In one embodiment, as shown in FIG. 2, an electrode grid is provided for use as an electrode plate 30. However, any suitable current collector could be used as an electrode plate 30. Two types of negative active material pastes, capacitor paste, and lead oxide paste, are added to different portions of an electrode grid: a capacitor region 20, and a traditional negative region 18. The capacitor paste is added to a bottom portion of the grid. Lead oxide paste is added to a portion of the grid that does not contain capacitor paste. The orientation of the capacitor region 20 on the bottom of the electrode plate 30 has a beneficial effect for flooded lead-acid batteries.

Gas production, through overcharging, is harmful to other lead-acid batteries, including valve regulated lead acid (“VRLA”) batteries. However, as described above, in flooded lead-acid batteries, batteries are often overcharged to decrease stratification of the acid electrolyte. Thus, in flooded lead-acid batteries, some gas production is desired to reduce stratification and therefore lengthen the life of the battery.

In the hybrid negative plate design, the capacitor region accepts the bulk of the high rate charge first, thus it is fully charged before the traditional negative region is charged. The capacitor region continues to receive some charge during charging. Overcharging of the capacitor region, situated at a bottom of the negative plate, results in gas production at the bottom of the plate, and thus, the bottom of the battery compartment. Because gas bubble production is localized at a bottom region of the battery compartment, the bubbling more efficiently mixes the more concentrated portion of the electrolyte. Furthermore, because bubbling begins at the bottom region prior to the battery being fully charged, less overcharge is required, and less water is consumed in the hydrolysis reaction. Based on this phenomenon, overcharging can be reduced from 10% overcharging that is now commonly used, to as low as 2% overcharging. The reduced electrolyte consumption and efficient mixing may lengthen the cycle life of the battery and may additionally reduce maintenance on the battery. Furthermore, the reduced amount of overcharge may result in less total energy used to charge the battery, a significant energy savings over the life of the battery. Additionally, the high current capability of the capacitor region may decrease the amount of lead sulfate formed on the negative electrode, also extending the cycle life of the battery.

As used in this application, “bottom” and “below” are intended to refer to the orientation of a flooded lead-acid battery during use. Accordingly, when the capacitor region is described as being “below” the traditional region or the capacitor region is described as being at the “bottom” of the plate, the capacitor region is generally at a lower region of the battery during battery operation.

According to embodiments of the invention, the capacitor region may occupy from 5%-95% of a negative hybrid plate. In some embodiments, the capacitor region occupies about 0-60% of a negative hybrid plate and the traditional region occupies about 40-100% of the negative hybrid plate. In some embodiments, the capacitor region occupies about 15-50% of a negative hybrid plate and the traditional region occupies about 50-85% of the negative hybrid plate. In one embodiment of the invention, about 30% of the plate is occupied by the capacitor region, and about 70% is occupied by the traditional region.

According to one embodiment of the invention, a capacitor paste for a flooded lead-acid battery includes lead oxide and a capacitor additive. The capacitor additive may be a carbon additive or any suitable material, nonlimiting examples of which include carbon black, graphite, and activated carbon. Other materials traditionally used in capacitors are well known to those of ordinary skill in the art. The capacitor additive preferably has a high surface area. The capacitor paste may optionally include other additives.

According to embodiments of the invention, carbon additive is provided to the paste to yield about 1% to about 20% of the mass of the lead oxide. This generally corresponds to a lead to carbon mass ratio for the capacitor paste of from about 5:1 to 82:1. In one embodiment of the invention, the amount of carbon added to the capacitor paste is about 3% of the mass of the lead oxide (corresponding to a lead to carbon mass ratio of about 30:1). According to embodiments of the invention, a mixture of different carbon additives may be used. For example, various combinations of carbon black, graphite, and activated carbon may be used. In some embodiments, carbon black, graphite, and activated carbon are present in the capacitor paste in a 1:1:1 weight ratio. In some embodiments, it may be beneficial for carbon black, graphite, and activated carbon to be present in a 1:1:4 weight ratio.

According to embodiments of the invention, the additives used in traditional pastes may be included in the capacitor paste. Such additives may include an expander and a binder. A suitable expander used in traditional negative pastes is a mixture of BaSO₄, Lignin, and carbon black. As a result of carbon in the expander, the traditional paste may contain about 0.15 wt % carbon (a lead to carbon mass ratio of about 630:1). Due to varying amounts of expander used, the traditional paste may have a lead to carbon mass ratio of between about 300:1 to 1900:1 (between about 0.05-0.3 wt % carbon). A binder used in traditional negative pastes could be polyester fiber. Suitable additional binders for the capacitor paste include carboxymethyl cellulose, neoprene, polyvinylidene fluoride (PVDF) or polytetrafluoroethylene (PTFE). Additional binder is generally not needed when the carbon in the capacitor paste is less than or equal to about 4% of the mass of the lead oxide. Throughout the specification, the amount of carbon in the expander is not included in the calculations of the percentages of carbon in the capacitor paste, but is included in the calculations of the mass ratios of lead to carbon.

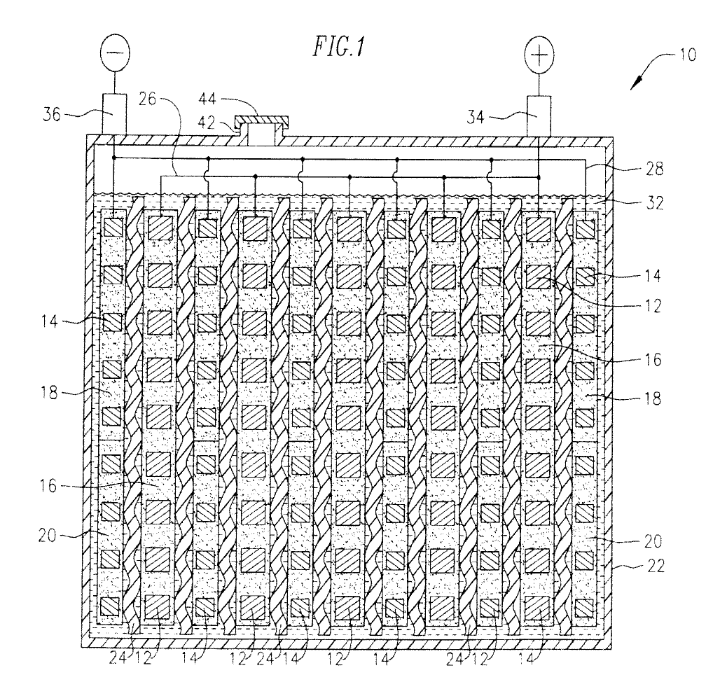

In one embodiment, as shown schematically in FIG. 1, a single cell flooded deep discharge lead-acid battery 10 includes the negative hybrid plates as set forth above. The battery includes a plurality of positive electrode grids 12, and a plurality of negative electrode grids 14. Each positive electrode grid is coated with a positive active material paste 16 to form a positive plate. Each negative electrode grid is coated with a lead oxide paste 18 and a capacitor paste 20 to form a negative plate. The coated positive and negative electrode grids are arranged in an alternating stack within a battery case 22 using a plurality of separators 24 to separate each electrode grid from adjacent electrode grids and prevent short circuits. A positive current collector 26 connects the positive electrode grids and a negative current collector 28 connects the negative electrode grids. An electrolyte solution 32 fills the battery case, and positive and negative battery terminal posts 34, 36 extend from the battery case to provide external electrical contact points used for charging and discharging the battery. The battery case includes a vent 42 to allow excess gas produced during the charge cycle to be vented to atmosphere. A vent cap 44 prevents electrolyte from spilling from the battery case. While a single cell battery is illustrated, it should be clear to one of ordinary skill in the art that the invention can be applied to multiple cell batteries as well.

According to one embodiment, the negative electrode grids are made from a lead-antimony alloy. In one embodiment, the electrode grids are alloyed with about 1.5 wt % to about 11 wt % antimony. In other embodiment the electrode grids may be alloyed with lead, calcium, and tin; lead and calcium; or up to 6 wt % antimony. Traditional negative electrode grids are coated with a negative active material that includes lead oxide as is well known in the art. Upon battery formation, the lead oxide of the negative active material is converted to lead.

The positive electrode grids are similarly made from an alloy of lead and antimony, but generally include more antimony than the alloy used for the negative electrode grids. The positive electrode grids also tend to be somewhat thicker than the negative electrode grids. Such positive and negative electrode grids and common materials used to manufacture them are well known in the art.

Suitable electrolytes include aqueous acid solutions. In one embodiment, the electrolyte comprises a concentrated aqueous solution of sulfuric acid having a specific gravity of about 1.1 to about 1.3 prior to battery formation. The separators could be made from any one of known materials. Suitable separators could be made from wood, rubber, glass fiber mat, cellulose, poly vinyl chloride, or polyethylene.

The present invention will now be described with reference to the following examples. These examples are provided for illustrative purposes only, and are not intended to limit the scope of the present invention.

### Example 1

### Capacitor Paste and Capacitor Negative Plate Formation

Carbon negative active material pastes were made by first mixing 10 lbs of lead oxide powder, 3.8 grams of polyester fiber, and 0.135 lbs of expander and carbon additives in a mixer. The lead oxide powder used in the Examples contained some pure lead. The weight of the pure lead plus the weight of the lead in the lead oxide was 94.69 wt % of the lead oxide powder. The expander in each paste comprised 0.1 lbs BaSO₄, 0.02 lbs Lignin Vanisperse A, and 0.015 lbs carbon black. The carbon additives used in various examples include carbon black, graphite, activated carbon and combinations of these materials. Specific amounts and types of carbon additives used for each plate are described in specific examples. The amount of carbon additive throughout the trials varied from about 1% to about 12% of the mass of lead oxide. If the amount of carbon additive is greater than 4% of the mass of lead oxide, an extra binder (such as carboxymethyl cellulose) is added. Then, 543 grams of sulfuric acid and water were added and mixing was continued until capacitor pastes were formed having the particular cube weight, paste densities, and moisture content described in Tables 2 and 4. Generally, the paste density decreased as the amount of carbon additives and water increased. The moisture content of the plates was measured using an infrared moisture analyzer.

The carbon negative paste was applied to identical negative electrode grids by hand using a spatula or commercially using a Mac Engineering & Equipment Co. commercial pasting machine to form pasted negative plates. The negative electrode grids were cast using a Wirtz Manufacturing Co. grid casting machine using a lead-antimony alloy with 2.75% antimony. Each negative electrode grid was pasted with the capacitor paste. The resulting negative plates were then dried in a flash drying oven according to well known methods. The dried negative capacitor plates were then cured by a two-step process in a curing chamber, first at 100% humidity for sixteen hours, and the plates were then dried under high temperature without humidity until the moisture content inside the plate was below 2%.

### Comparative Example 1

### Traditional Negative Paste and Traditional Negative Plate Formation

A traditional negative paste, identical to the paste described at Example 1 was made using the method described at Example 1, however, no carbon additive was used. The traditional negative paste was applied to negative electrode grids as in Example 1, and processed as in Example 1 to form a traditional negative plate.

### Example 2

### Hybrid Negative Plate Formation

A traditional negative paste described in Comparative Example 1 was applied to the top portion of negative electrode grids and a capacitor paste described in Example 1 was applied to the bottom portion of negative electrode grids. The surface area of negative electrode grids covered by carbon negative paste varied between about 14% and about 48% of the negative electrode grids. The resulting hybrid negative plates were then processed as described in Example 1 to form hybrid negative plates.

### Examples 1-2 and Comparative Example 1

### Cell Assembly

Each set was assembled into a 2-volt single cell jar. Each cell contained 6 positive and 6 negative plates. The plates were placed in an alternating arrangement with conventional separators between them. The positive plates comprised a positive electrode grid. Each positive electrode grid was pasted with positive paste comprising lead oxide, polyester fiber, water, and sulfuric acid. The plates were then processed in the same way as the negative plates.

The tabs of the negative plates of each cell were welded together using known procedures. Similarly, the tabs of the positive plates of each cell were welded together using known procedures. The assembled cells were then filled with aqueous sulfuric acid. Within thirty minutes of filling the cells with acid, the plate formation step was initiated. According to the plate formation step, a charge was applied to the cells using a constant current formation procedure to form the plates. The formation was terminated when the total charge energy reached 190-220% of the theoretical charge energy based on the quantity of positive active material and charging efficiency. The final specific gravity of the aqueous sulfuric acid inside the cells was about 1.28.

### Examples 3-4 and Comparative Example 1

For Examples 3 and 4, cells were created as described above. In Example 3, capacitor negative plates were formed according to Example 1. The capacitor plates of Example 3 contained capacitor paste having carbon equal to 4% of the mass of lead oxide, and the capacitor paste was pasted onto the whole negative electrode grid. The 4% carbon paste of Example 3 contained 2% carbon black and 2% graphite. In Example 4, hybrid negative plates were formed according to Example 2. The capacitor paste of Example 4 contained carbon paste having carbon equal to 4% of the mass of lead oxide, and the capacitor paste was pasted onto the lower region of the negative electrode grid. The remainder of the negative electrode grid of Example 4 was pasted with traditional negative paste. The surface area of negative electrode grid covered by carbon paste was 48% of total surface of the negative grid.

For Comparative Example 1 traditional negative plates of were used, as described above. The cells of Examples 3, 4, and Comparative Example 1 were identical except for the type of negative plate used.

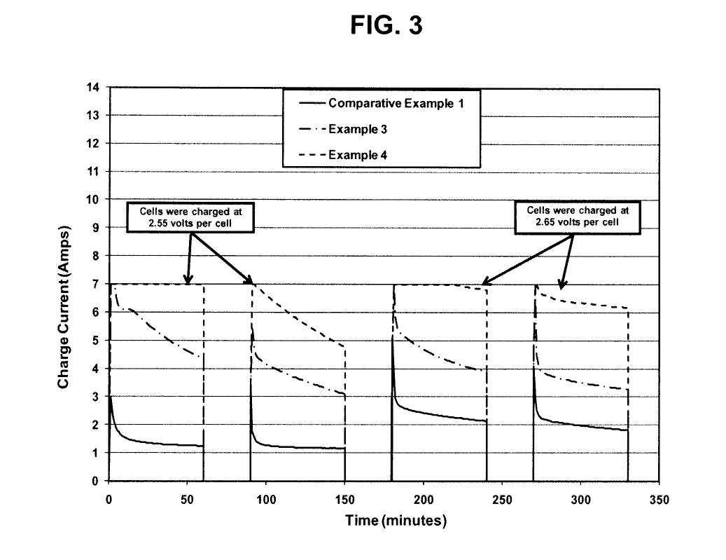

For the first test, cells were charged at 2.55 V and 2.65 V for two hours. The results of the test are depicted in FIG. 3, which graphs voltage against time. FIG. 3 shows that the current drops as the cell voltage reaches the charging voltage. After the cell voltage reached charging voltage, the continued charging current produced gassing. The gassing rates of each cell from high to low are Example 4, Example 3, and Comparative Example 2. Thus, FIG. 3 indicates that the hybrid negative plate causes more gassing than a traditional negative plate. This is consistent with the theory that a hybrid negative plate can more quickly and efficiently mix the electrolyte solution and require less overcharging than a traditional negative electrode.

### Examples 5-12 and Comparative Example 2

For Examples 5-7, negative capacitor plates were prepared as in Example 1, containing carbon additives as described in Table 1. For Examples 8-12, hybrid negative plates were prepared as in Example 2 with various plate area coverage and various carbon pastes as described in Table 1. For Comparative Example 2, traditional negative plates were prepared according to Comparative Example 1.

TABLE 1

| | | Area of Negative |
|---|---|---|
| | Negative | Electrode Grid Covered |
| Example | Paste | by Carbon Paste (%) |
| Comparative | N0 only | 0% |
| Example 2 | | |
| 5 | C0 only | 100% |
| 6 | C1 only | 100% |
| 7 | C2 only | 100% |
| 8 | Hybrid (N0/C0) | 14% |
| 9 | Hybrid (N0/C0) | 31% |
| 10 | Hybrid (N0/C0) | 48% |
| 11 | Hybrid (N0/C1) | 14% |
| 12 | Hybrid (N0/C2) | 14% |

Note
X % means X % of the weight of the lead oxide
1. N0: Traditional Negative Paste
2. C0: Traditional Negative Paste + 4% Carbon Additive (2% Carbon Black, 2% Graphite)
3. C1: Traditional Negative Paste + 8% Carbon Additive (4% Carbon Black, 4% Graphite) + 2% carboxymethyl cellulose binder
4. C2: Traditional Negative Paste + 12% Carbon Additive (6% Carbon Black, 6% Graphite) + 4% carboxymethyl cellulose binder

TABLE 2

| | N0 | C0 | C1 | C2 |
|---|---|---|---|---|
| Cube Weight (g/4 in. cube) | 275 | 248 | 173 | 151 |
| Paste Density (g/cm³) | 4.2 | 3.78 | 2.64 | 2.30 |
| Moisture Content (%) | 12.50 | 13.95 | 27.80 | 31.00 |

For the tests, the batteries were repeatedly discharged and charged. In particular, the batteries were discharged at a constant 20 amps down to a cut-off voltage of 1.75 V per cell. For each circuit, the total discharged capacity for each discharge cycle was determined in runtime (minutes). Once the batteries of a circuit were discharged, the circuit was rested for 30 minutes before recharging. After the rest step, the batteries were recharged using a three-step I-E-I charge profile up to 110% of the capacity discharged on the immediately preceding discharge cycle. In this 3-step charge profile, the first step employs a constant start current in which charge current to the batteries is maintained at a constant value (in this case 14 A) during the initial charge stage until the battery voltage per cell reaches a specified level (in this case 2.35 VPC). In the second step, the battery voltage is maintained at a steady voltage while current is decreased. In the third step, a lower constant current is delivered to the batteries (in this case 4.0 A). Such a charge profile is abbreviated in this specification as “IEI 14A-2.35VPC-4.0A-110%.” Once recharged, the battery circuit was rested for two hours before being discharged.

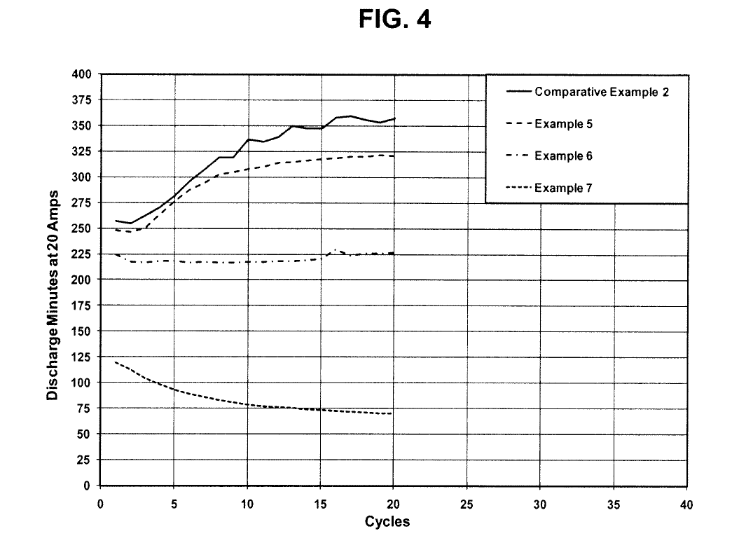

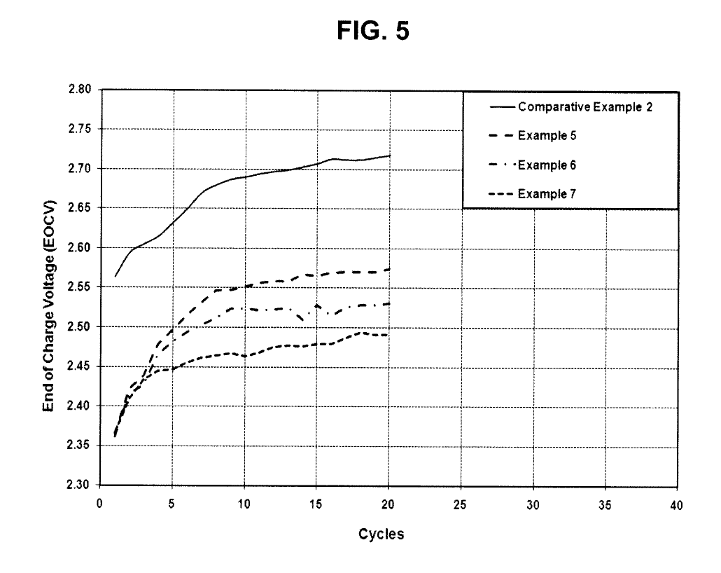

FIG. 4 shows the test results of Examples 5-7 and Comparative Example 2, showing the impact of the carbon additives on cell performance. FIG. 4 shows that carbon additive throughout the entire plate will decrease cell performance. The performance of Examples 6-7 is significantly lower than Comparative Example 2 because the traditional paste was entirely replaced by the capacitor paste. FIG. 5 shows the end of charge voltage for the tested cells. At the 3^{rd} stage of the IEI recharge profile, the cells had been fully charged, thus most of reaction occurring at this state is gassing and stirring electrolyte. Since the current was fixed (4.0 A) during this stage, lower end of charge voltage (“E.O.C.V.”) indicates that the negative capacitor plate behaves more like a capacitor. When there is a pulse charge current, as would occur in a regenerative braking system, the voltage of a cell with lower a E.O.C.V. (the negative capacitor plates) will increase less than a cell with higher E.O.C.V. (traditional negative plates).

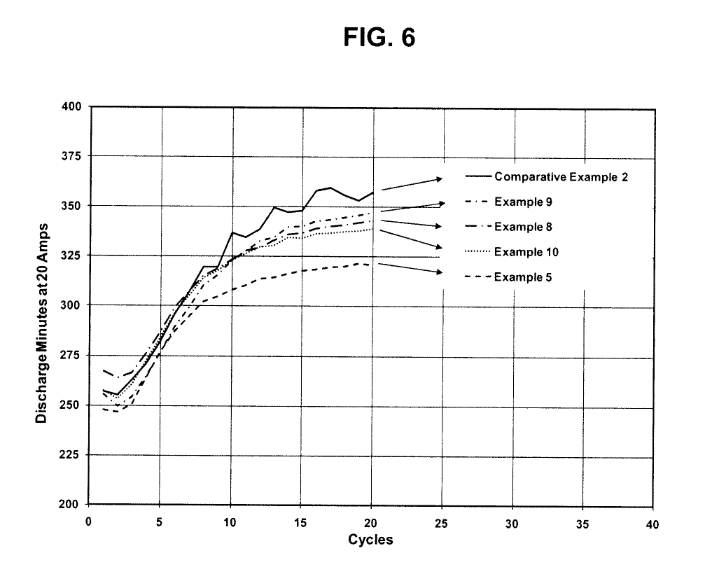

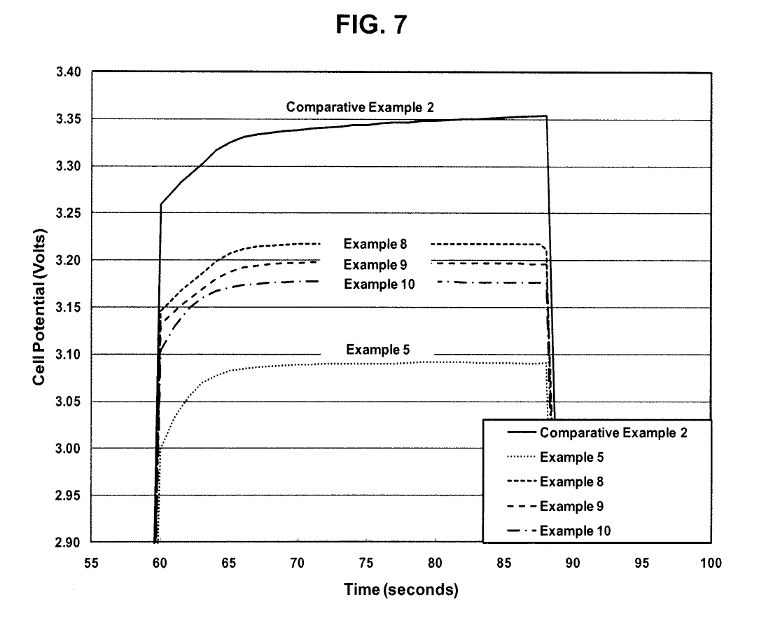

FIGS. 6-7 show the test results of Examples 5, 8-10, and Comparative Example 2. Examples 8-10 are cells containing hybrid negative plates as described in Table 1. FIG. 6 shows the cell performance during cycling testing. Examples 8-10, hybrid plate cells, had a performance (runtime) between Example 5, a capacitor plate cell, and Comparative Example 2, a traditional cell. The results indicate that hybrid negative plate design does not significantly harmfully affect cell performance (in runtime). FIG. 7 shows the change of cell voltage during 150 amp charging over a short period of time. The current (150 A) applied in the testing of FIG. 7 is similar to the current generated from a regenerative system of an electric vehicle (such as a golf car). FIG. 7 shows that the peak cell voltage decreases as the electrode area covered by carbon paste increases. This indicates that the hybrid negative plate design lowers the cell voltage caused by high pulse current charging. It also indicates that the design potentially eliminates the need for a voltage limiting resistor circuit to limit the regenerative system voltage (which is typically used to prevent damage other electrical components within the car).

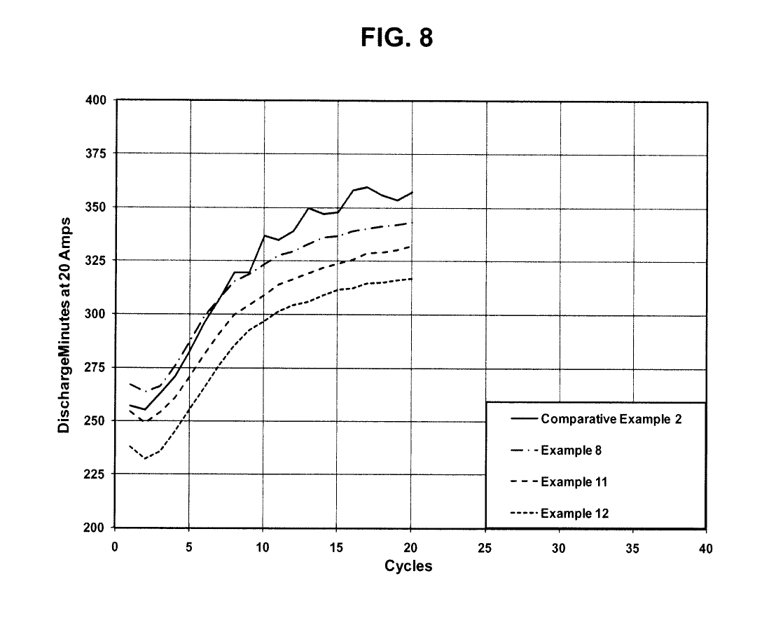

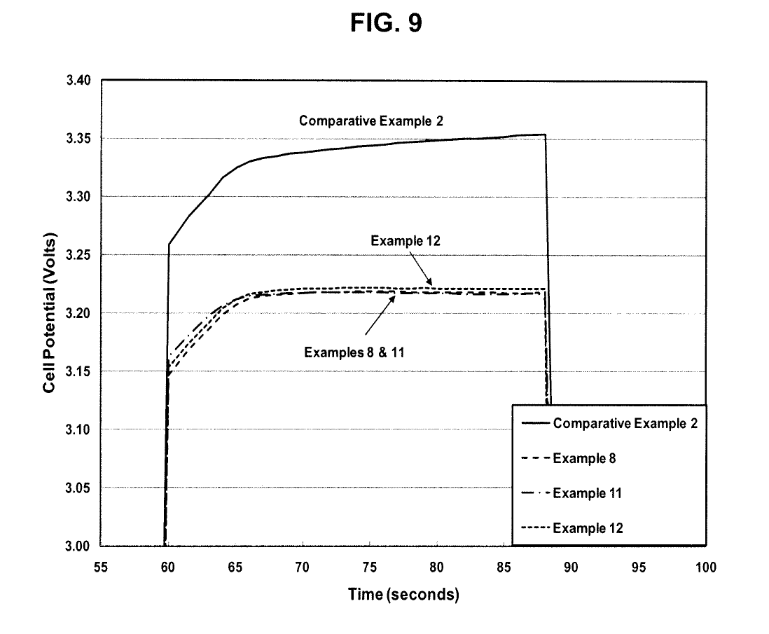

FIGS. 8-9 show the test results of Examples 8, 11-12, and Comparative Example 2. Examples 8 and 11-12 are cells containing hybrid negative plates where the electrode area covered by capacitor paste was kept constant (14%). FIG. 8 shows the cell performance during cycling testing. Example 12 shows the lowest performance, likely because the carbon content is the highest. The results have a similar trend as that shown in FIG. 4 and indicate that excessive carbon additives will decrease cell performance. FIG. 9 shows the changes of cell voltage during 150 amp charging over a short period of time. The peak voltages of Examples 8, 11 and 12 are very similar during 150 amp charging. This could be because the electrode area covered by carbon paste is not large enough to show significant changes due to varying amounts of carbon in each paste.

### Examples 13-14 and Comparative Example 3

In Example 13, negative capacitor plates were made according to Example 1. The negative capacitor plates of Example 13 contained capacitor paste having carbon additives equal to 3% of the weight of the lead oxide. The capacitor paste was pasted onto the whole negative electrode grid. The carbon additives used in Example 13 were an equal mixture of carbon black, graphite, and activated carbon. The activated carbon used had a surface area of approximately 1600 m²/g. In Example 14, hybrid negative plates were made according to Example 2. The capacitor paste of Example 14 contained the same carbon additives as in Example 13, equal to 3% of the weight of the lead oxide. The capacitor paste was pasted onto the lower region of the negative electrode grid. The surface area of the negative electrode grid covered by capacitor paste was 31% of total surface of the negative grid. This information is listed in Table 3 for clarity. For Comparative Example 3, traditional negative plates were prepared according to Comparative Example 1. Comparative Example 3 was created and used (instead of Comparative Examples 1 or 2) in order to eliminate variations between trials.

TABLE 3

| | | Area of Negative |
|---|---|---|
| | Negative | Electrode Grid Covered |
| Example | Paste | by Carbon Paste (%) |
| Comparative | N0 only | 0% |
| Example 3 | | |
| 13 | M0 only | 100% |
| 14 | Hybrid (N0/M0) | 31% |

Note
X % means X % of the weight of the lead oxide
1. N0: Traditional Negative Paste
2. M0: Traditional Negative Paste + 3% Carbon Additive (1% Carbon Black, 1% Graphite, 1% Activated Carbon)

TABLE 4

| | N0 | M0 |
|---|---|---|
| Cube Weight (g/4 in. cube) | 280 | 240 |
| Paste Density (g/cm³) | 4.27 | 3.66 |
| Moisture Content (%) | 11.20 | 15.05 |

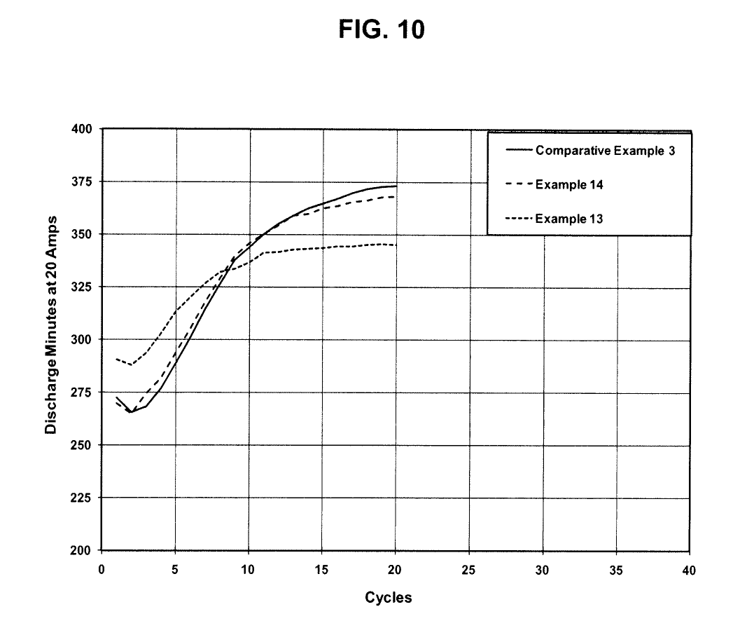

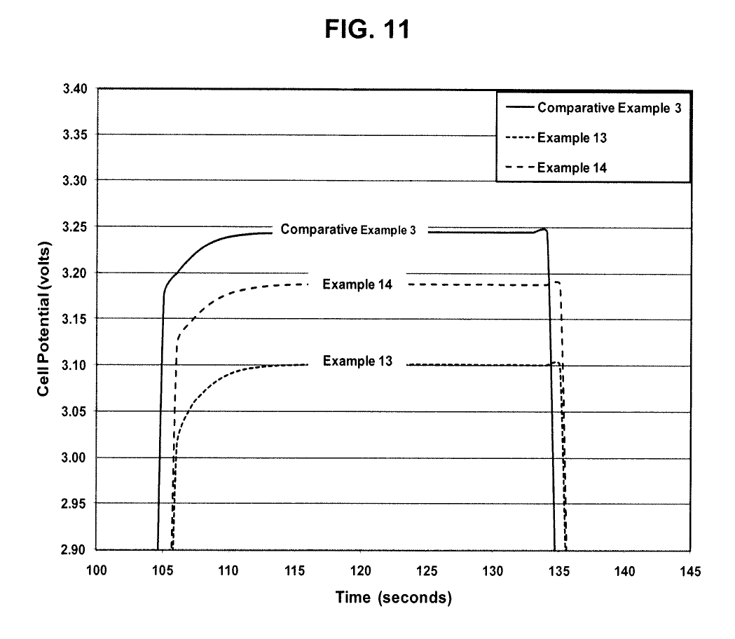

FIGS. 10-11 show the test results of Examples 13-14 and Comparative Example 3. Example 14 is the cell containing hybrid negative plates. The tests were intended to help determine the impact of activated carbon in capacitor paste. FIG. 10 shows the cell performance during cycling testing. Example 14, the hybrid plate cell, had a performance (runtime) between Example 13, the capacitor plate cell, and Comparative Example 3, a traditional cell. These examples exhibit a trend similar to that as shown in FIG. 6. FIG. 11 shows the change of cell voltage during 150 amp charging. Again, the examples exhibit a trend similar to that as shown in FIG. 7.

### Examples 15-18 and Comparative Example 4

Each of Examples 15-18 and Comparative Example 4 were formed into cells containing 2 positive and 3 negative plates. In Examples 15-16, negative capacitor plates were made according to Example 1. The negative capacitor plates of Example 15 contained capacitor paste having carbon additives equal to 4% of the weight of the lead oxide. The capacitor paste was pasted onto the whole negative electrode grid. The carbon additives used in Example 15 were an equal mixture of carbon black and graphite. The cube weight, paste density, and moisture content of Example 15 are shown in Table 2 under the column C0. The negative capacitor plates of Example 16 contained capacitor paste having carbon additives equal to 12% of the weight of the lead oxide. The capacitor paste was pasted onto the whole negative electrode grid. The carbon additives used in Example 16 were an equal mixture of carbon black and graphite. The cube weight, paste density, and moisture content of Example 16 are shown in Table 2 under column C2. Carboxymethyl cellulose binder was also added to Example 16 in an amount equal to 4% of the weight of the lead oxide.

In Examples 17-18, negative hybrid plates were made according to Example 1. The negative hybrid plates of Example 17 contained carbon additives in the capacitor region equal to 4% of the weight of the lead oxide. The capacitor paste was pasted onto the lower region of the negative electrode grid (“bottom-hybrid plates”). The surface area of negative electrode grid covered by capacitor paste was 52% of total surface of the negative grid. The negative hybrid plates of Example 18 contained carbon additives in the capacitor region equal to 4% of the weight of the lead oxide. The capacitor paste was pasted onto a side region of the negative electrode grid, specifically the side away from the terminal (“side-hybrid plate”). The surface area of negative electrode grid covered by capacitor paste was 55% of total surface of the negative grid. The cube weight, paste density, and moisture content of Examples 17-18 are shown in Table 2 under column C0.

For Comparative Example 4, traditional negative plates were prepared according to Comparative Example 1. The cube weight, paste density, and moisture content of Comparative Example 4 are shown in Table 2 under column N0.

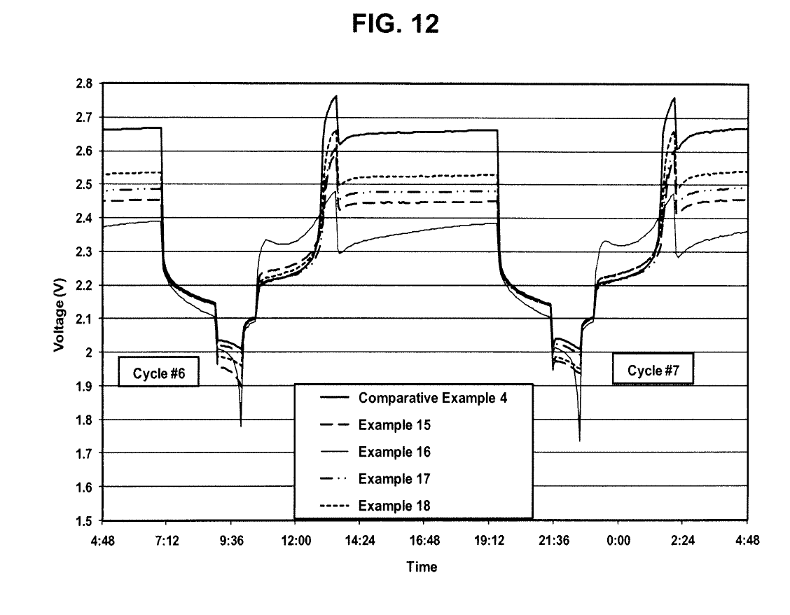

FIGS. 12-15 show the test results of Examples 15-18 and Comparative Example 4. For the first test, the cells were repeatedly discharged and charged using standard procedures as established by Battery Council International. In particular the cells were discharged at 10 amps for 1 hour, rested for a short time, and then charged at 4 amps for 3 hours and then 1 amp for 2 hours, followed by approximately 2 hours of rest. The results of the test are shown in FIG. 12, which graphs voltage against time. FIG. 12 shows the effect of the amount of carbon in the capacitor region, the orientation of capacitor region, and entire capacitor negative plates on charge and discharge. The cells with bottom-hybrid plates performed very similarly to a traditional negative plate.

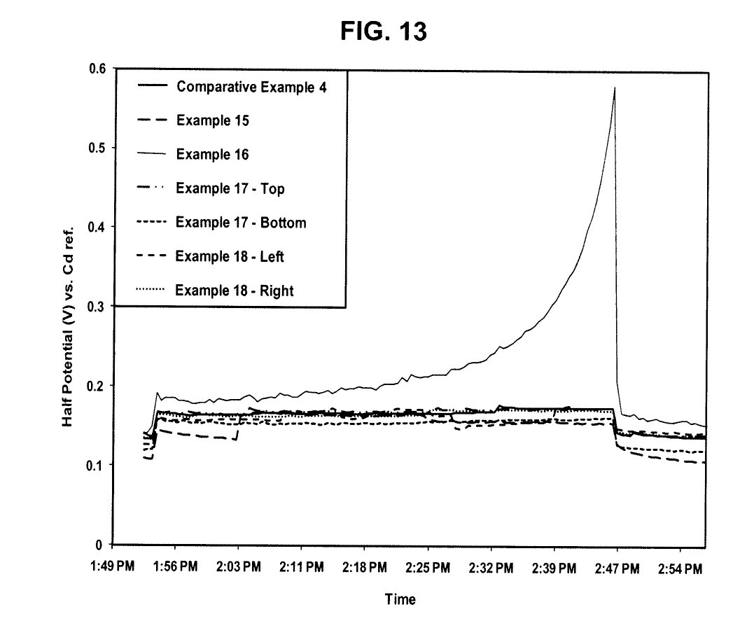

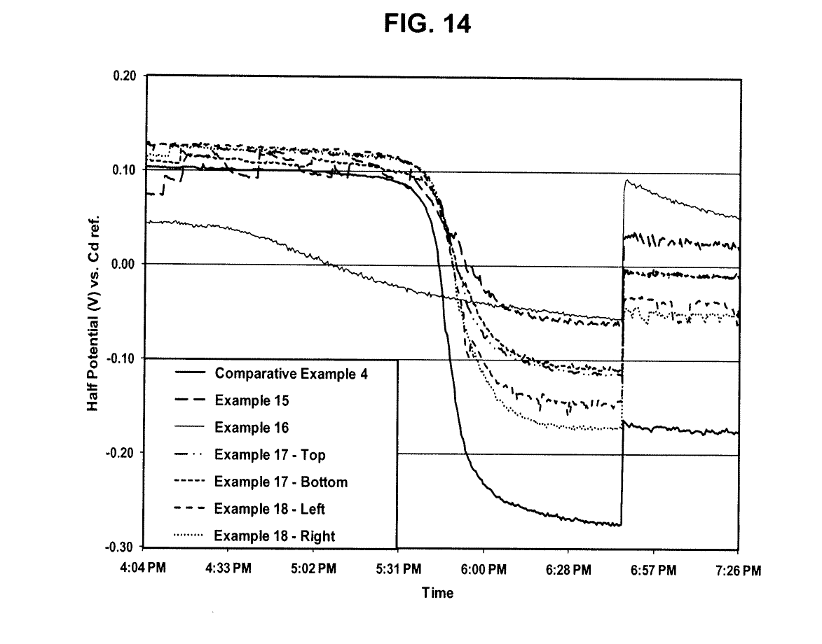

Next, the half potentials of the circuits were measured during charge (at 15 amps for 52 minutes) and discharge (at 5 amps for 3.5 hours and 1 amp for 2 hours). The half potential was measured against a cadmium reference electrode. The results of the half potential tests are shown in FIG. 13 (discharge) and FIG. 14 (charge), both graphing half potential (V) versus a cadmium reference against time. FIG. 13 shows that there no discernable difference between traditional negative paste and the hybrid plates. FIG. 14 shows that the traditional negative paste plate has the highest half potential. The side-hybrid plate showed a lower voltage than the traditional plate, but the bottom-hybrid plate showed an even lower voltage. Thus, FIG. 14 shows that the bottom-hybrid plate requires a lower voltage before gassing begins than the traditional plate and the side-hybrid plate.

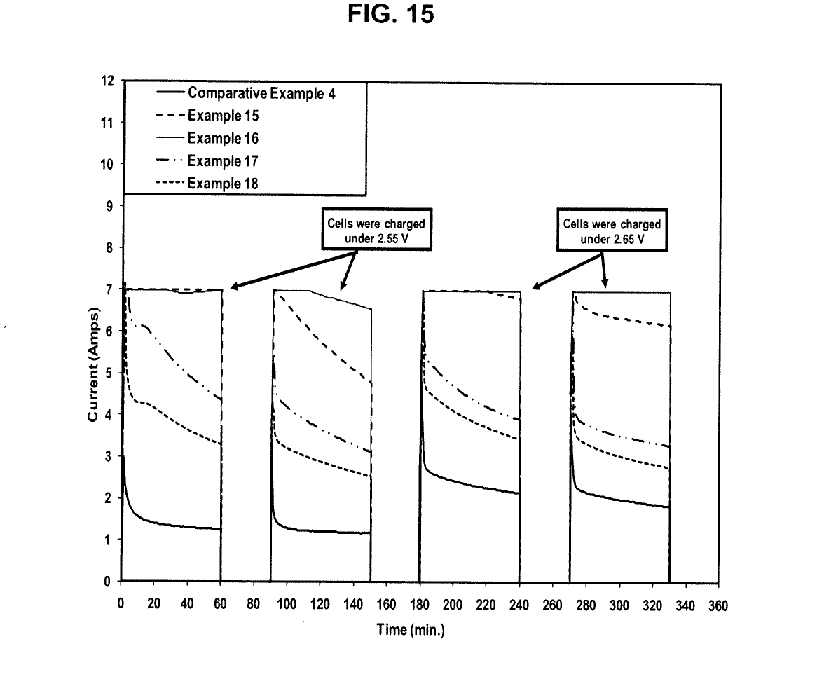

Next, an overcharge test was performed. The cells were charged at 2.55 and 2.65 V for two hours. The results of the test are shown in FIG. 15, graphing current against time. FIG. 15 shows the current dropping as the cell voltage reaches the charging voltage. After the cell voltage reaches charging voltage, the continued charging current produces gassing. Thus, FIG. 15 confirms the results of the previous test, namely, that the bottom-hybrid plate produces more gassing than either the side-hybrid plate or the traditional plate. This is consistent with the theory that a bottom-hybrid plate can more quickly and efficiently mix the electrolyte solution and require less overcharging than a traditional negative electrode.

While the present invention has been illustrated and described with reference to certain exemplary embodiments, those of ordinary skill in the art would appreciate that various modifications and changes can be made to the described embodiments without departing from the spirit and scope of the present invention, as defined in the following claims.

What is claimed is:

1. A negative electrode plate for a flooded lead-acid battery comprising:
an electrode grid defining first and second grid regions, the second grid region oriented below the first grid region;
a first negative active material comprising lead and coating the first grid region; and
a second negative active material comprising carbon and coating the second grid region.

2. The negative electrode plate of claim 1, wherein the second grid region comprises between 5% and 95% of the area of the electrode grid.

3. The negative electrode plate of claim 2, wherein the second grid region comprises between 15% and 50% of the area of the electrode grid.

4. The negative electrode plate of claim 1, wherein the second negative active material comprises carbon selected from the group consisting of carbon black, graphite, activated carbon, and combinations thereof.

5. The negative electrode plate of claim 4, wherein carbon black, graphite, and activated carbon are present in a 1:1:1 weight ratio.

6. The negative electrode plate of claim 4, wherein carbon black, graphite, and activated carbon are present in a 1:1:4 weight ratio.

7. The negative electrode plate of claim 1, wherein the second negative active material comprises carbon and lead and has a lead to carbon mass ratio of about 5:1 to about 82:1.

8. The negative electrode plate of claim 7, wherein the second negative active material has a lead to carbon mass ratio of about 30:1.

9. A flooded lead-acid rechargeable battery comprising:
at least one positive electrode plate;
at least one negative electrode plate comprising:
an electrode grid defining first and second grid regions, the second grid region oriented below the first grid region;
a first negative active material comprising lead and coating the first grid region; and
a second negative active material comprising carbon and coating the second grid region; and
an electrolyte.

10. The flooded lead-acid battery of claim 9, wherein the second grid region comprises between 15% and 50% of the area of the electrode grid.

11. The flooded lead-acid battery of claim 9, wherein the second negative active material comprises carbon selected from the group consisting of carbon black, graphite, activated carbon, and combinations thereof.

12. The flooded lead-acid battery of claim 11, wherein carbon black, graphite, and activated carbon are present in a 1:1:4 weight ratio.

13. The flooded lead-acid rechargeable battery of claim 9, wherein the second negative active material has a lead to carbon mass ratio of about 30:1.

14. A negative electrode plate for a flooded lead-acid battery comprising:
an electrode grid defining first and second grid regions;
a first negative active material comprising lead and coating the first grid region; and
a second negative active material comprising carbon and lead, having a lead to carbon mass ratio of about 5:1 to about 82:1, and coating the second grid region.

15. The negative electrode of claim 14, wherein the lead to carbon mass ratio of the second negative active material is about 30:1.

16. The negative electrode of claim 14, wherein the second grid region is below the first grid region.

17. The negative electrode of claim 14, wherein the second negative active material comprises carbon selected from the group consisting of carbon black, graphite, activated carbon, and combinations thereof.

18. The negative electrode of claim 17, wherein carbon black, graphite, and activated carbon are present in a 1:1:4 weight ratio.

19. The negative electrode of claim 17, wherein carbon black, graphite, and activated carbon are present in a 1:1:1 weight ratio.

20. The negative electrode of claim 14, wherein the second grid region comprises between 15% and 50% of the area of the electrode grid.
